(19) United States
(12) Patent Application Publication
(10) Pub. No.: US 2025/0001866 A1
(43) Pub. Date: Jan. 2, 2025

(54) VEHICLE DISPLAY SYSTEM

(71) Applicant: DENSO CORPORATION, Kariya-city (JP)

(72) Inventor: Keiji OKAMOTO, Kariya-city (JP)

(21) Appl. No.: 18/882,381

(22) Filed: Sep. 11, 2024

Related U.S. Application Data
(63) Continuation of application No. PCT/JP2023/010446, filed on Mar. 16, 2023.

(30) Foreign Application Priority Data
Mar. 21, 2022 (JP) 2022-044793

(51) Int. Cl. B60K 35/29; B60K 35/22; B60K 35/28; B60K 35/81

(52) U.S. Cl. CPC B60K 35/29; B60K 35/22; B60K 35/28; B60K 35/81; B60K 2360/166; B60K 2360/182; B60K 2360/184

(57) ABSTRACT

A vehicle display system includes display regions, a display controller and a switching controller. The display controller controls respective displayed contents of the display regions. The switching controller executes switching between a synchronous mode and an asynchronous mode, and executes switching to the synchronous mode while continuing to show a predetermined image in a synchronization source being one of the display regions by maintaining a display setting of the synchronization source. The synchronous mode is a mode in which the displayed contents are synchronized, and the asynchronous mode is a mode in which the displayed contents are not synchronized. The synchronization source is one of the display regions.

### CROSS REFERENCE TO RELATED APPLICATIONS

The present application is a continuation application of International Patent Application No. PCT/JP2023/010446 filed on Mar. 16, 2023, which designated the U.S. and claims the benefit of priority from Japanese Patent Application No. 2022-044793 filed on Mar. 21, 2022. The entire disclosures of all of the above applications are incorporated herein by reference.

### TECHNICAL FIELD

The present disclosure relates to a vehicle display system.

### BACKGROUND

A vehicle navigation device may display a map on two display regions, one on the left and another one on the right. One map may be a detailed map and the other may be a broad-scale map. The detailed map and the broad-scale map may scroll synchronously.

### SUMMARY

The present disclosure describes a vehicle display system that includes display regions, a display controller, and a switching controller.

### BRIEF DESCRIPTION OF DRAWINGS

FIG. 1 illustrates a state in which a vehicle display system according to a first embodiment is adapted to a vehicle.

FIG. 2 illustrates a configuration of a display control apparatus.

FIG. 3 illustrates displayed contents of a Center Information Display (CID) and a meter display in an asynchronous mode.

FIG. 4 illustrates the displayed contents of the CID and the meter display in a synchronous mode.

FIG. 5 illustrates a process executed by a controller according to a first embodiment.

FIG. 6 illustrates a process executed by a controller according to a second embodiment.

FIG. 7 illustrates the displayed contents of the CID and the meter display in the synchronous mode.

FIG. 8 illustrates the displayed contents of the CID and the meter display in the asynchronous mode.

FIG. 9 illustrates a state in which a vehicle display system according to a third embodiment is adapted to a vehicle.

FIG. 10 illustrates a configuration of a display control apparatus according to the third embodiment.

FIG. 11 illustrates the displayed contents of the CID and a passenger display in the asynchronous mode.

FIG. 12 illustrates a process executed by a controller according to the third embodiment.

FIG. 13 illustrates the displayed contents of the CID and the passenger display in the synchronous mode.

### DETAILED DESCRIPTION

In a vehicle display system having multiple display regions, it may be inconvenient for vehicle occupants if the multiple display regions are always synchronized.

A vehicle display system according to an aspect of the present disclosure includes display regions, a display controller and a switching controller. The display controller controls respective displayed contents of the display regions. The switching controller executes switching between a synchronous mode and an asynchronous mode, and execute switching to the synchronous mode while continuing to show a predetermined image in a synchronization source being one of the display regions by maintaining a display setting of the synchronization source. The synchronous mode is a mode in which the displayed contents are synchronized, and the asynchronous mode is a mode in which the displayed contents are not synchronized. The synchronization source is one of the display regions.

This vehicle display system includes the switching controller that executes switching between the synchronous mode and the asynchronous mode. The synchronous mode is a mode in which the respective displayed contents of the display regions are synchronized, and the asynchronous mode is a mode in which the respective displayed contents of the display regions are not synchronized. Thus, this vehicle display system provides higher convenience for an occupant of a vehicle as compared with a system in which multiple display regions are normally synchronized and another system in which multiple display regions are normally not synchronized. Additionally, the switching controller maintains a display setting of a synchronization source to ensure that a predetermined image continues to be displayed in the synchronization source in a case where the switching controller executes the switching to the synchronous mode. Thus, the occupant of the vehicle can continuously check the image displayed in the synchronization source so that the vehicle display system provides higher convenience for the occupant.

### First Embodiment

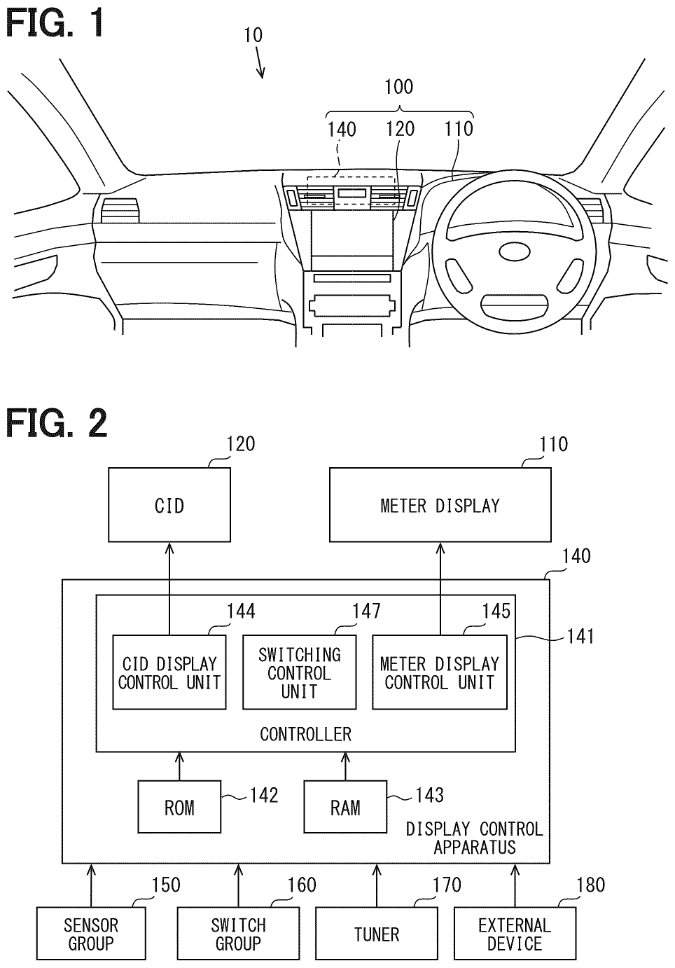

Hereinafter, a first embodiment of the present disclosure will be described with reference to the drawings. FIG. 1 illustrates a state in which a vehicle display system 100 according to the first embodiment is adapted to a vehicle 10. As shown in FIG. 1, the vehicle display system 100 includes a meter display 110, a Center Information Display (CID) 120, and a display control apparatus 140.

The meter display 110 is a display that provides a display region for a driver. The meter display 110 is located in front of the driver's seat in the vehicle 10. The meter display 110 displays meters such as a speedometer. The meter display 110 may be located in any position as long as it is visible to the driver. The meter display 110 may be disposed above CID 120 in the center of the dashboard in the vehicle width direction.

The meter display 110 does not necessarily need to display an image of the meter. The meter may also be an analog meter, and a display that is arranged near the analog meter and displays various images can also be the meter display 110. In this embodiment, the meter display 110 can display a map of the surroundings of the vehicle 10.

The CID 120 is disposed at the center of the dashboard in the vehicle width direction. Since the CID is located at the above-mentioned position, the CID 120 is also visible to the driver. However, a person on a front passenger seat and a person on a back seat can also see the CID 120. The CID 120 can be considered as a passenger display in comparison to the meter display 110. That is, the CID 120 is a display that provides a display region for the passengers. The CID 120 can display various information. For example, CID 120 can display maps, television images, and other video images. The front passenger seat may also be referred to as a driver assistant seat.

The display control apparatus 140 is a control apparatus that controls the displayed contents of the meter display 110 and the CID 120. In FIG. 1, the display control apparatus 140 is located outside the meter display 110 and the CID 120. However, the display control apparatus 140 may be housed within the housing of the CID 120 or the meter display 110. In addition, some of the functions of the display control apparatus 140 may be accommodated within the housings of the meter display 110 and the CID 120.

FIG. 2 shows the configuration of the display control apparatus 140. The display control apparatus 140 includes a controller 141, a ROM 142, and a RAM 143. The controller 141 includes at least one processor. In this embodiment, the ROM 142 stores map data. In addition, the ROM 142 stores a display control program executed by the controller 141. The processor executes the display control program stored in the ROM 142 while utilizing the temporary storage function of the RAM 143, so that the controller 141 operates as a CID display control unit 144, a meter display control unit 145, and a switching control unit 147. Execution of the program corresponds to execution of a method corresponding to the program for display control. The “control unit” may also be referred to as a controller.

The display control apparatus 140 receives a detection signal from a sensor group 150 and a switch operation signal from a switch group 160. The sensor group 150 may include a vehicle speed sensor that detects the speed of the vehicle 10. The sensor group 150 may also include a rotation speed sensor that detects the rotation speed of the engine. The switch group 160 includes switches that are operated by the occupant to change the displayed content of the CID 120. The switches may be either or both of touch switches overlaid on the display surface and mechanical switches disposed around the periphery of CID 120. The switch group 160 also includes switches that the driver operates to change the displayed content of the meter display 110. Other examples of switches included in the switch group 160 are an air conditioner switch for operating the air conditioning, an audio switch for operating the audio, a light switch for operating the lights, and a mode switch for operating the driving mode.

Furthermore, a television video signal from a tuner 170 and an external input signal from an external device 180 are also provided to the display control apparatus 140. The external device 180 is, for example, a smartphone, and the external input signal is a video signal received by the smartphone.

The controller 141 controls the respective displayed contents of the meter display 110 and the CID 120 based on data stored in the ROM 142 and various signals provided to the display control apparatus 140.

The CID display control unit 144 controls the displayed content of the CID 120. To control the displayed content of CID 120, the CID display control unit 144 obtains image generation data from the ROM 142, the sensor group 150, the switch group 160, the tuner 170, and the external device 180. Then, the CID display control unit 144 generates a display image (hereinafter, a CID image) to be displayed on the CID 120 based on the acquired image generation data, and displays the generated CID image on the CID 120.

The meter display control unit 145 controls the displayed content of the meter display 110. In order to control the displayed contents of the meter display 110, the meter display control unit 145 obtains image generation data for generating a display image to be displayed on the meter display 110. The image generation data acquired by the meter display control unit 145 is obtained from the ROM 142 and the sensor group 150. Furthermore, the meter display control unit 145 may obtain image generation data from a source other than the ROM 142 and the sensor group 150, such as the switch group 160. The meter display control unit 145 generates a display image (hereinafter, meter image) based on the acquired image generation data, and displays the generated meter image on the meter display 110. In addition, the meter display 110 may also be provided with an image generator, and an image that is a combination of the meter image generated by the meter display control unit 145 and the display image generated by the image generator provided in the meter display 110 may be displayed on the meter display 110.

The switching control unit 147 switches between the synchronous mode and the asynchronous mode. The synchronous mode is a mode in which the contents displayed in the display regions are synchronized. In the present embodiment, the multiple display regions are the meter display 110 and the CID 120. The synchronization described herein is not limited to displaying the same image. The synchronization also includes having same display settings. In this embodiment, the condition for switching between the synchronous mode and the asynchronous mode is that a switching operation is performed by the occupant.

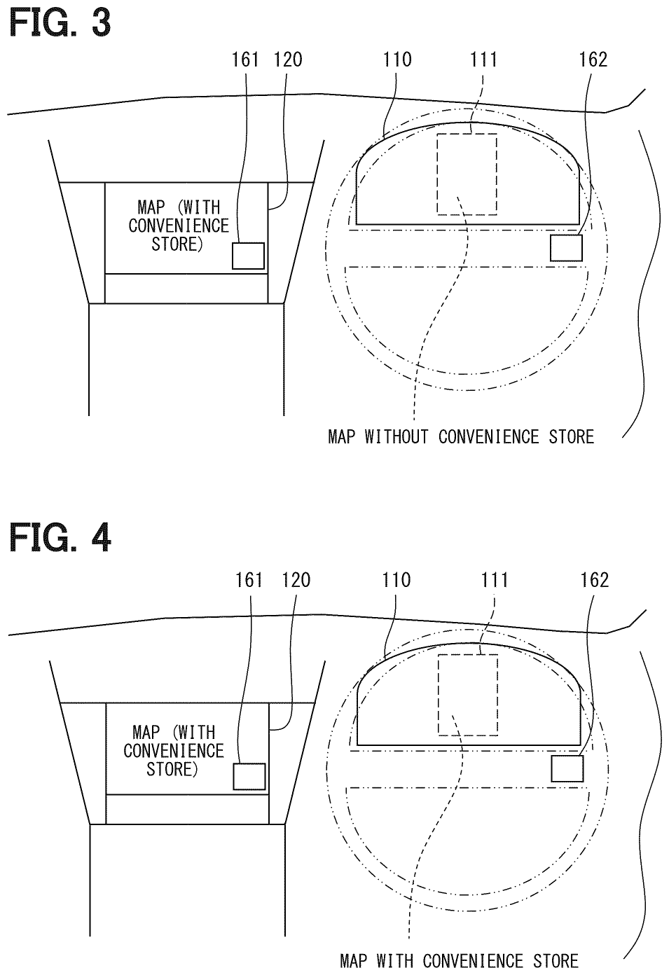

FIG. 3 illustrates the respective displayed contents of the CID 120 and the meter display 110 in the asynchronous mode. The CID 120 displays a map. The map displayed on CID 120 is set so that stopover convenience stores are included in the displayed facility types for which icons are displayed. The meter display 110 also displays a map in a map display region 111. The map displayed in the map display region 111 is set so that icons of stopover convenience stores are not displayed. The map displayed in the map display region 111 is a simplified map compared to the map displayed in the CID 120 in that stopover convenience store icons are not displayed.

As shown in FIG. 3, a synchronization switch 161 is displayed on the CID 120. The synchronization switch 161 is one switch included in the switch group 160. Since a touch switch is superimposed on the display surface of the CID 120, when the occupant operates the region where the synchronization switch 161 is displayed, an operation signal indicating the operation is provided to the display control apparatus 140. As mentioned above, the CID 120 is a display that provides a viewing region for a passenger. The synchronization switch 161 displayed on this CID 120 is a passenger synchronization switch. The synchronization switch 161 may be a mechanical switch, that is, a physical switch, disposed around the CID 120.

As shown in FIG. 3, a synchronization switch 162 is disposed on the steering wheel. The synchronization switch 162 is a mechanical switch. The synchronization switch 162 may be a push switch or a slide switch. The synchronization switch 162 is a driver's synchronization switch.

If the CID display control unit 144 detects an operation signal indicating that either the synchronization switch 161 or the synchronization switch 162 has been operated, and the operation signal is received in the asynchronous mode, it switches to the synchronous mode. Moreover, if the mode is in the synchronous mode when an operation signal is received, the mode may be switched to the asynchronous mode. In other words, the synchronization switch 161 may be a switch that switches between the synchronous mode and the asynchronous mode every time it is operated. It is also possible to provide a switch for switching from the synchronous mode to the asynchronous mode and another switch for switching from the asynchronous mode to the synchronous mode separately.

FIG. 4 illustrates the displayed contents of the CID 120 and the meter display 110 in the synchronous mode. In FIG. 4, the map displayed on the CID 120 and the map displayed in the map display region 111 of the meter display 110 are both set to display icons of stopover convenience stores.

### Process Executed by Controller 141

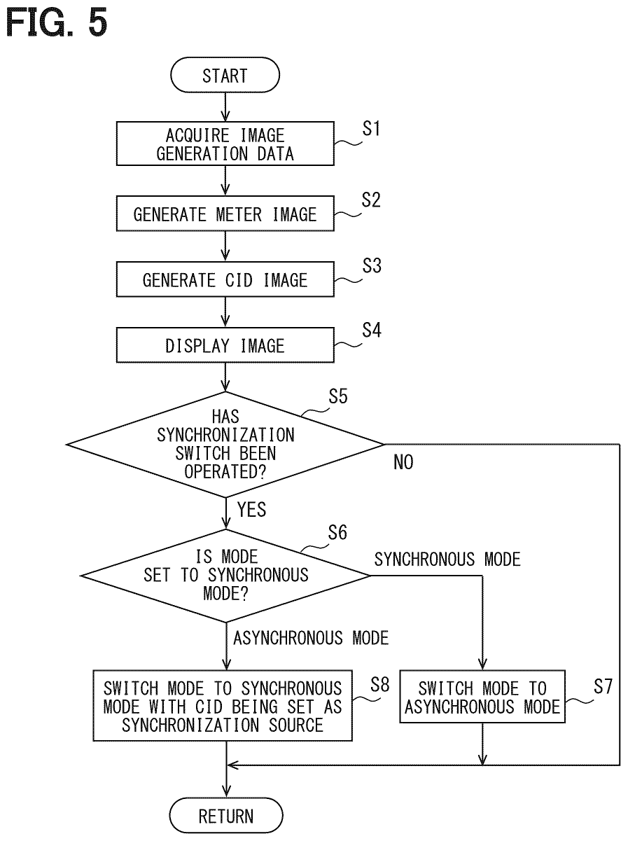

The following describes the flow of a process executed by the controller 141 with reference to FIG. 5. The controller 141 repeats the process shown in FIG. 5 at regular intervals. In S1, the CID display control unit 144 and the meter display control unit 145 obtain image generation data for generating a CID image and a meter image.

In S2, the meter display control unit 145 generates the meter image based on the image generation data acquired in S1. In S3, the CID display control unit 144 generates the CID image based on the image generation data acquired in S1.

In S4, the meter display control unit 145 displays the meter image generated in S2 on the meter display 110, and the CID display control unit 144 displays the CID image generated in S3 on the CID 120.

The switching control unit 147 executes S5 and subsequent processing. In S5, it is determined whether or not the synchronization switch 161 or the synchronization switch 162 has been operated. This operation is a switching operation. When the determination result in S5 is negative (NO), the process returns to S1. When the determination result of S5 is affirmative (YES), the process proceeds to S6.

In S6, the present synchronization setting is determined. If the present synchronization setting is the synchronous mode, the process proceeds to S7. In S7, the synchronous setting is switched to the asynchronous mode. After switching to the asynchronous mode, the passenger can set the displayed contents of the meter display 110 and the CID 120 separately. The displayed contents of the meter display 110 and the CID 120 can be set, for example, by displaying a display setting screen on the CID 120 and operating the display setting screen. Immediately after switching to the asynchronous mode, if the passenger is not performing any operation, the display settings immediately before switching to the asynchronous mode can be maintained until the passenger changes the display settings. Alternatively, the display settings may be restored to a state before switching to the synchronous mode.

S6 is executed, and if the present synchronization setting is the asynchronous mode, the process proceeds to S8. In S8, when either the synchronization switch 161 or the synchronization switch 162 is operated, the mode is switched to a synchronous mode in which the CID 120 is used as the synchronization source. Therefore, in the state shown in FIG. 3, when the synchronization switch 161 or the synchronization switch 162 is operated, a map set to display stopover convenience store icons is displayed in the map display region 111, as shown in FIG. 4. At this time, the image displayed on the synchronization source CID 120 continues to be a map with the display of icons of stopover convenience stores. That is, the image determined by maintaining the display settings remains displayed on the synchronization source CID 120.

### Summary of First Embodiment

As described above, the vehicle display system 100 has the switching control unit 147 for switching the contents displayed on the meter display 110 between the synchronous mode and the asynchronous mode. The synchronous mode is a mode in which the contents are synchronized. The asynchronous mode is a mode in which the contents are asynchronous. The above-mentioned configuration provides greater convenience for the occupants of the vehicle 10, as compared with a system in which the respective display settings of the meter display 110 and the CID 120 are normally in synchronization and another system in which the display settings of the meter display 110 and the CID 120 are not normally in synchronization.

As an example of an improvement in convenience, it is assumed that a passenger is sitting on the front passenger seat and needs to search for a stopover convenience store where the vehicle 10 will stop. In this case, the asynchronous mode is selected as shown in FIG. 3, and the passenger sitting in the front passenger seat uses the CID 120 to search for a stopover convenience store where vehicle 10 will stop at. There are often many stopover convenience stores in the surrounding of the vehicle 10. When the synchronous mode is selected, it is possible that icons of many stopover convenience stores may be displayed in the map display region 111 as well. If too many stopover convenience store icons are displayed in the map display region 111, it may be difficult to understand road information necessary for driving. However, if the asynchronous mode is selected, stopover convenience store icons will not be displayed in the map display region 111, making it possible to prevent road information necessary for driving from becoming difficult to understand.

When the person on the front passenger seat has decided which stopover convenience store to stop at, the person on the front passenger seat presses the synchronization switch 161 so that an icon of the stopover convenience store is also displayed in the map display region 111. This eliminates the need to go through the trouble of setting a destination after deciding which stopover convenience store to visit.

In addition, when the mode is switched to the synchronous mode in S8, the switching control unit 147 switches to the synchronous mode while maintaining the display settings and displaying the determined image in the CID 120 as the synchronization source. Therefore, the occupants of the vehicle 10 can continue to check the image of the synchronization source. This also provides higher convenience to the user.

The vehicle display system 100 includes the synchronization switches 161 and 162 that are operated by an occupant of the vehicle 10 to issue a synchronization instruction. The switching control unit 147 switches to the synchronous mode based on the operation of the synchronization switches 161 and 162 in S5, S6, S8. This configuration allows the occupant of the vehicle 10 to synchronize the displayed contents of the meter display 110 and the CID 120 at any time.

In addition, when the synchronization switch 162 is operated to switch to the synchronous mode; and when the synchronization switch 161 is operated to switch to the synchronous mode, the switching control unit 147 sets the displayed content of the CID 120 as the synchronization source in S8. Therefore, it is not possible to synchronize the CID 120 with the meter display 110 as the synchronization source. This prevents the driver from accidentally setting the synchronization source map while driving, which may result in the driver losing focus on driving.

### Second Embodiment

The following describes a second embodiment. In the description of the second and subsequent embodiments, elements having the same reference numerals as those used so far are identical to the elements having the same reference numerals in the previous embodiment(s), unless otherwise specified. When only a part of the configuration is described, the embodiment described above can be applied to other parts of the configuration.

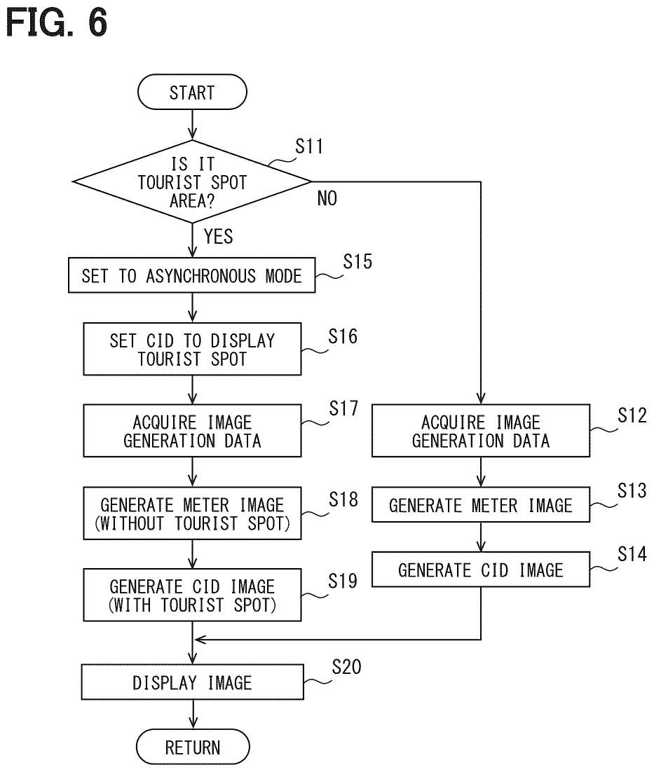

FIG. 6 illustrates a process executed by the controller 141 in the second embodiment. In the second embodiment, instead of the process shown in FIG. 5, the controller 141 executes the process shown in FIG. 8. The controller 141 may execute both the process shown in FIG. 5 and the process shown in FIG. 6. When both of the process illustrated in FIG. 5 and the process illustrated in FIG. 6 are executed, S5 and subsequent processing in FIG. 5 are executed after S20 in FIG. 6.

In FIG. 6, in S11, the switching control unit 147 determines whether or not the present position of the vehicle 10 is in a tourist area. The tourist spot area is defined in the map data stored in the ROM 142. If the determination result of S11 is negative (NO), the process proceeds to S12.

In S12, the CID display control unit 144 and the meter display control unit 145 acquire image generation data for generating the CID image and the meter image. S13 is the same as S2 in FIG. 5, and the meter display control unit 145 generates the meter image based on the image generation data acquired in S12. S14 is the same as S3 in FIG. 5, and the CID display control unit 144 generates the CID image based on the image generation data acquired in S12. After execution in S14, the process proceeds to S20.

When the determination result in S11 is affirmative (YES), the process proceeds to S15. In S15, the switching control unit 147 sets the synchronization setting to the asynchronous mode. If the asynchronous mode is in effect before S15 is executed, the asynchronous mode is maintained. If the synchronous mode is in effect before S15 is executed, the mode is switched to the asynchronous mode.

In S16, the CID display control unit 144 adds the tourist spot to the displayed facility types whose icons are displayed on the map displayed on the CID 120. In other words, the number of types of facilities displayed is increased. Since the asynchronous mode has been set immediately before in S15, even if the display setting of the CID 120 is changed, the display setting of the meter display 110 is not affected.

In S17, the CID display control unit 144 and the meter display control unit 145 acquire image generation data for generating the CID image and the meter image. In S17, the CID display control unit 144 also acquires data for displaying tourist spots from the ROM 142. On the other hand, the meter display control unit 145 may acquire the same data as in S12.

In S18, the meter display control unit 145 generates the meter image based on the image generation data acquired in S17. The meter image generated by the meter display control unit 145 in S18 is the same as the meter image generated by the meter display control unit 145 in S13.

In S19, the CID display control unit 144 generates the CID image based on the image generation data acquired in S17. If a map is displayed on the CID 120 and tourist spots are included in the display area, the CID image generated in S19 is an image showing the map including icons indicating the tourist spots. After execution in S19, the process proceeds to S20.

In S20, the meter display control unit 145 displays the meter image generated in S13 or S18 on the meter display 110, and the CID display control unit 144 displays the CID image generated in S14 or S19 on the CID 120.

In the second embodiment, when the present location of the vehicle 10 is in a tourist area and the displayed content to be displayed on the CID 120 is a map, the map is set in advance to include tourist spots. On the other hand, the map display region 111 is set not to display tourist spots so as not to obscure road information necessary for driving.

Therefore, if the present location of the vehicle 10 is in the tourist area (S11: YES) and the synchronization setting at that time is the synchronous mode, the switching control unit 147 switches the synchronization setting to the asynchronous mode in S15.

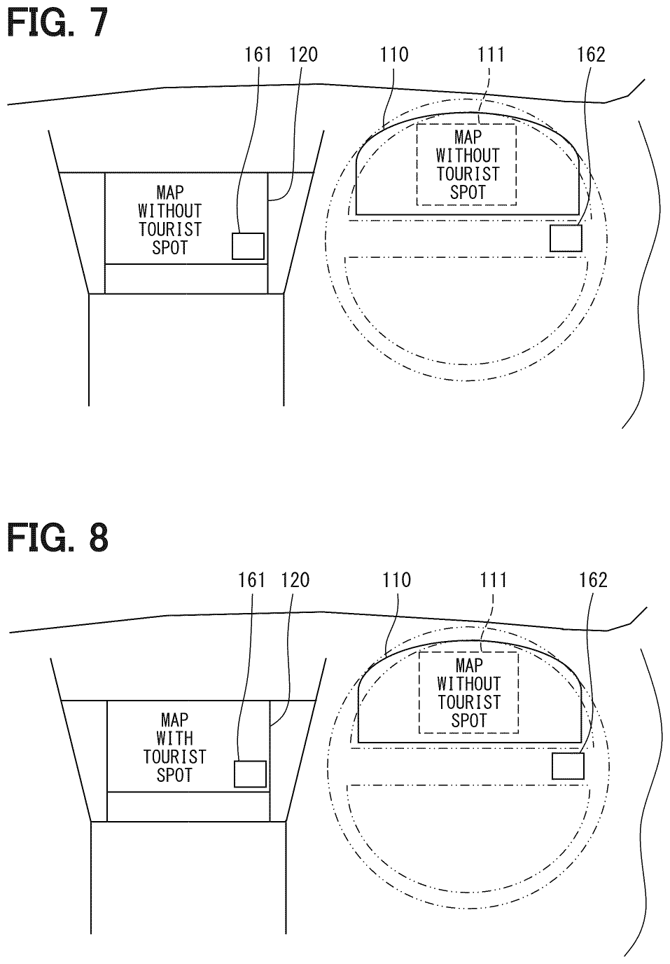

FIG. 7 illustrates the displayed contents of the CID 120 and the meter display 110 before the execution of S15. In FIG. 7, the map displayed on the CID 120 and the map displayed in the map display region 111 are in the synchronous mode, and are both set not to display tourist spots. In contrast, FIG. 8 illustrates the displayed contents of the CID 120 and the meter display 110 when S20 is executed through S15 to S19. In FIG. 8, the map displayed on the CID 120 is set to display tourist spots. On the other hand, the map displayed in the map display region 111 is set not to display tourist spots.

With the configuration related to the second embodiment, a map with a large amount of information is displayed on the CID 120 even without any operation by an occupant. Thus, the occupant who does not need to operate the vehicle can view the map with a large amount of information and acquire a lot of information. Even if the number of types of facilities displayed on the map displayed on the CID 120 increases, the map is set to the asynchronous mode in S15, so that the map displayed in the map display region 111 does not include icons indicating tourist spots. Thus, it is possible to inhibit a situation in which the road information required for driving cannot be acquired.

### Third Embodiment

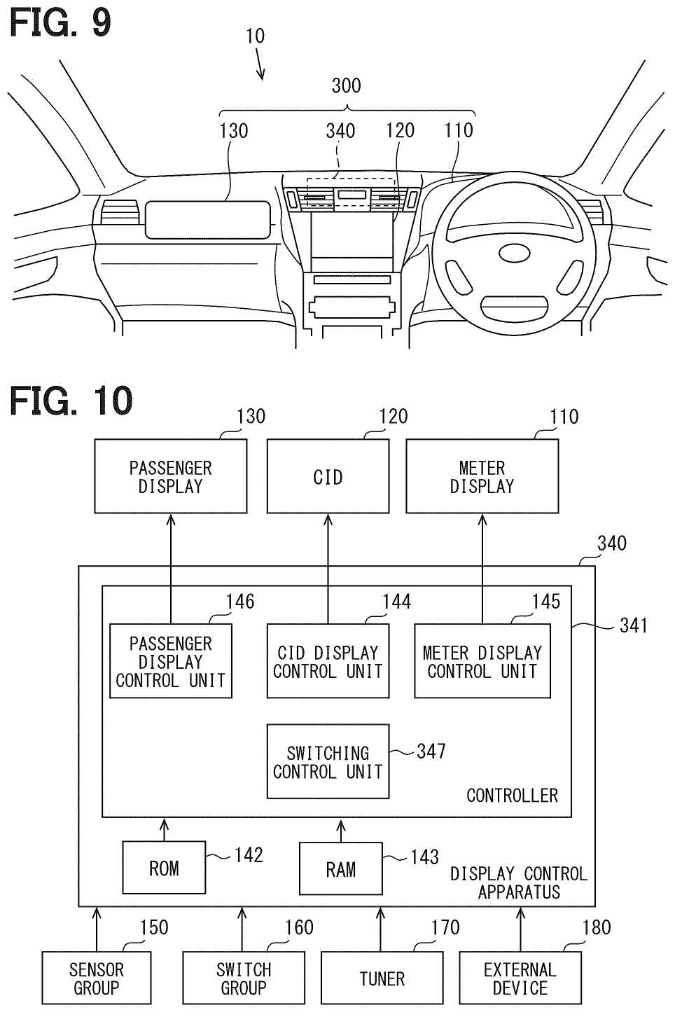

FIG. 9 shows a state in which a vehicle display system 300 according to a third embodiment is adapted to the vehicle 10. The vehicle display system 300 includes the meter display 110, the CID 120, and a passenger display 130 as displays. The vehicle display system 300 includes a display control apparatus 340.

The passenger display 130 is disposed on the dashboard in a position directly in front of the front passenger seat. The passenger display 130 is a display that provides a display region for the front passenger seat. The passenger display 130 can display a variety of images. The passenger display 130 may be capable of displaying, for example, a map, a television image, another video simultaneously or by switching between them.

The CID 120 is easier to be viewed than the passenger display 130 by an occupant sitting on the back seat. Thus, the CID 120 is a display that provides a viewing region for the occupant sitting on the back seat.

FIG. 10 illustrates the configuration of the display control apparatus 340. The display control apparatus 340 includes a controller 341, the ROM 142, and the RAM 143. The controller 341 includes at least one processor. The ROM 142 stores a program designed for display control to be executed by the controller 341. The processor executes the display control program stored in the ROM 142 while utilizing the temporary storage function of the RAM 143, so that the controller 342 operates as the CID display control unit 144, the meter display control unit 145, the passenger display control unit 146 and a switching controller 347.

The passenger display control unit 146 controls the displayed content of the passenger display 130. In order to control the displayed content of the passenger display 130, the passenger display control unit 146 acquires image generation data from the ROM 142, the sensor group 150, the switch group 160, the tuner 170, and the external device 180. Then, the passenger display control unit 146 generates a display image (hereinafter, passenger image) to be displayed on the passenger display 130 based on the acquired image generation data, and displays the generated passenger image on the passenger display 130.

The switching controller 347 switches between the synchronous mode and the asynchronous mode for display regions. The number of display regions to be switched between the synchronous mode and the asynchronous mode can be set arbitrarily as long as it is two or more. In the following, it is assumed that the targets to be switched between the synchronous mode and the asynchronous mode are the CID 120 and the passenger display 130. In this embodiment, the condition for switching between the synchronous mode and the asynchronous mode is that a switching operation is performed by the occupant.

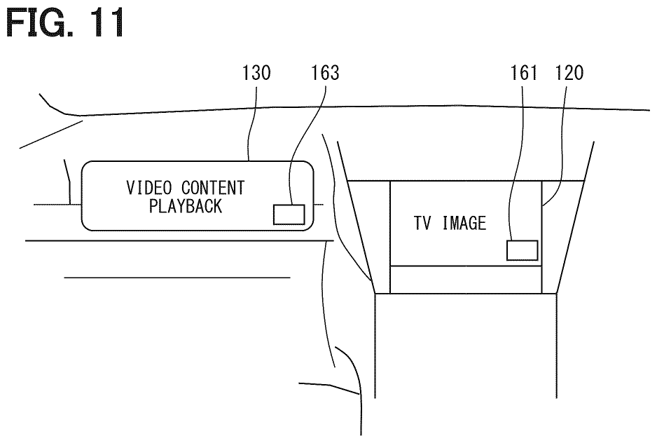

FIG. 11 illustrates the respective displayed contents of the CID 120 and the passenger display 130 in the asynchronous mode. A television image is displayed on the CID 120. On the passenger display 130, a video content provided from the external device 180 is being played.

As shown in FIG. 11, the passenger display 130 displays a synchronization switch 163. The synchronization switch 163 is also a switch included in the switch group 160. A touch switch is also superimposed on the display surface of the passenger display 130. Thus, when an occupant touches the region where the synchronization switch 163 is displayed, an operation signal indicating that the synchronization switch 163 has been operated is provided to the display control apparatus 340. As described above, the passenger display 130 is a display that provides a display region for the front passenger seat. Therefore, the synchronization switch 163 displayed on the passenger display 130 is the synchronization switch for the front passenger's seat. The synchronization switch for the front passenger seat may be a mechanical switch arranged around the passenger display 130.

In this embodiment, the CID 120 is a display that provides a display region for the back seat, and the synchronization switch 161 displayed on the CID 120 is a synchronization switch for the back seat. The synchronization switch for the back seat may be a switch provided on a remote controller that transmits an operation instruction signal to the CID 120 remotely.

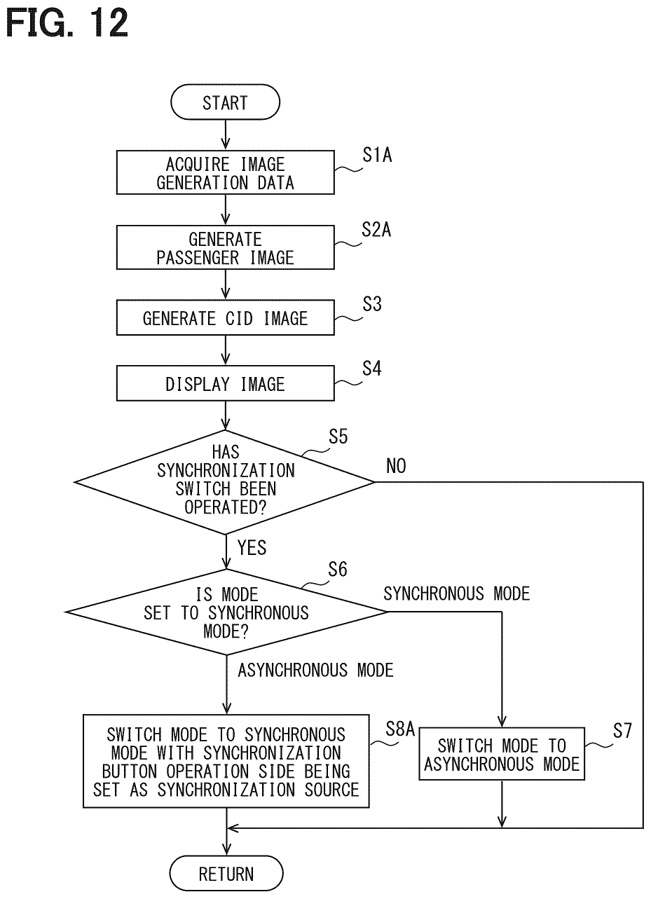

FIG. 12 illustrates a process executed by the controller 341 according to a third embodiment. The process shown in FIG. 12 is similar to the process shown in FIG. 5. The difference between the process shown in FIG. 12 and the process shown in FIG. 5 is that S1A, S2A, and S8A are executed in FIG. 12 instead of S1, S2, and S8 in FIG. 5. The process shown in FIG. 12 can be combined with the process shown in FIG. 5.

When the process shown in FIG. 12 is combined with the process shown in FIG. 5, if the synchronization switches 161, 162 are pressed and the targets for synchronization/asynchronization operation are set to the meter display 110 and the CID 120, the process shown in FIG. 5 is executed. If the synchronization/asynchronization target is set to the CID 120 and the passenger display 130, the process shown in FIG. 12 is executed.

In S1A, the CID display control unit 144 and the passenger display control unit 146 acquire image generation data for generating the CID image and the passenger image.

In S2A, the passenger display control unit 146 generates a passenger image based on the image generation data acquired in S1A.

S8A is a process executed when the synchronization switch 161 or the synchronization switch 163 is operated (S5: YES) and the synchronization setting is set to the asynchronous mode. In S8A, the switching controller 347 switches to a synchronous mode in which the synchronization button operation side is the synchronization source. Therefore, when the synchronization switch 161 is operated, the CID 120 becomes the synchronization source; and when the synchronization switch 163 is operated, the passenger display 130 becomes the synchronization source.

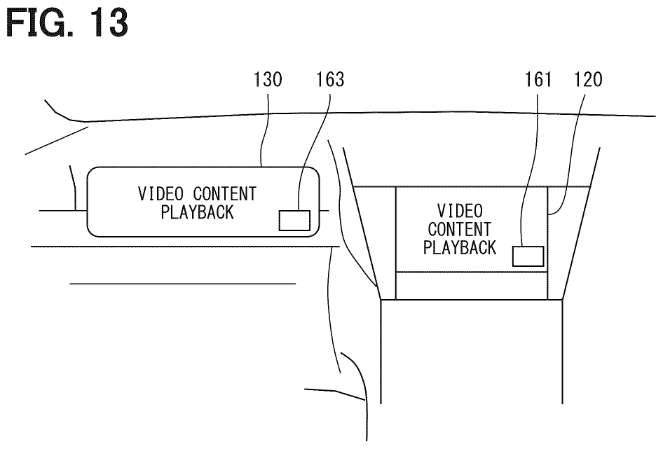

FIG. 13 illustrates a display example when the synchronization switch 163 is operated and S8A is executed in the state shown in FIG. 11. As shown in FIG. 13, the CID 120 also plays the same video content as the passenger display 130. On the other hand, although not shown in the drawing, when the synchronization switch 161 is operated to execute S8A in the state shown in FIG. 11, the displayed content of the CID 120 is maintained and a television image is displayed on the passenger display 130.

In the third embodiment, when the synchronization switches 161, 163 are operated to switch to the synchronous mode, the display corresponding to the operated synchronization switch 161, 163 is set as the synchronization source in S8A. The above configuration enhances convenience for both the occupant on the front passenger seat and the occupants on the back seats.

For example, in a case where a child sits on the back seat and a parent sits on the front passenger seat, the parent may select a video content and play it on the CID 120. First, the parent selects a video content on the passenger display 130. Thereafter, when the synchronization switch 163 is operated, the CID 120 is synchronized with the passenger display 130, and the video content being displayed on the passenger display 130 is also played on the CID 120. This allows the child sitting on the back seat to watch video content selected by his or her parent.

Although the embodiments of the present disclosure have been described above, the present disclosure is not limited to the above embodiments, and various modified examples described below are also included in the technical scope of the present disclosure. Furthermore, various modifications other than the following can be made without departing from the gist.

### First Modification

The display providing the driver viewing area may be a head-up display. In addition, the display that is the target of synchronous/asynchronous operation and provides a display region for the driver may be switched by an operation by the occupant between the meter display 110 and a head-up display. The passenger display 130 may be a display region for a passenger.

### Second Modification

In the above-mentioned embodiment, separate displays such as the meter display 110 and the CID 120 are provided. However, the display may be a pillar-to-pillar display, with a portion of the display being a display region for the driver and another portion being one or more of a display region for a passenger, a display region for the front passenger seat, and a display region for the back seat.

### Third Modification

In FIG. 6, in a case where the determination result of S11 is negative (NO), it is possible to perform the process of determining the synchronization setting and changing it to the synchronous mode before executing S12. In this way, switching from the asynchronous mode to the synchronous mode can be performed automatically without any operation by the occupant.

### Fourth Modification

When an operation for changing the display setting of each display is performed, the display may be switched to the asynchronous mode. This is because there is little need for screens for operations to change the display settings to be displayed synchronously.

### Fifth Modification

The controller 141, 341 and the method described in the present disclosure may be implemented by a special purpose computer including a processor programmed to perform one or more functions embodied by a computer program. Alternatively, the controller 141, 341 and the method described in the present disclosure may be implemented by a dedicated hardware logic circuit. Alternatively, the controller 141, 341 and the method described in the present disclosure may be implemented by one or more dedicated computers configured by a combination of a processor executing a computer program and one or more hardware logic circuits. The hardware logic circuits may be, for example, ASIC or FPGA.

The storage medium for storing the computer program is not limited to ROM. Alternatively, the computer program may be stored in a computer-readable, non-transitory tangible storage medium as instructions to be executed by a computer. For example, the program may be stored in a flash memory.

What is claimed is:

1. A vehicle display system comprising:
display regions including
a driver display region provided for a driver of the vehicle and capable of displaying a map, and
a passenger display region provided for a passenger of the vehicle and capable of displaying a map;
a display controller configured to control respective displayed contents of the display regions;
a switching controller configured to
execute switching between a synchronous mode and an asynchronous mode,
the synchronous mode being a mode in which the respective displayed contents of the display regions are synchronized such that number of facility types shown on the map displayed in the driver display region and number of facility types shown on the map displayed in the passenger display region are synchronized,
the asynchronous mode being a mode in which the respective displayed contents of the display regions are not synchronized such that the driver display region is capable of displaying a simplified map showing fewer facility types than the map displayed in the passenger display region, and
execute switching to the synchronous mode while continuing to show a predetermined image in a synchronization source that is one of the display regions by maintaining a display setting of the synchronization source; and
a synchronization switch configured to be switched based on a synchronization instruction provided by an occupant of a vehicle, wherein:
the switching controller is configured to execute the switching to the synchronous mode in response to switching of the synchronization switch.

2. A vehicle display system comprising:
display regions including
a driver display region provided for a driver of a vehicle and capable of displaying a map, and
a passenger display region provided for a passenger of the vehicle and capable of displaying a map;
a display controller configured to control respective displayed contents of the display regions; and
a switching controller configured to
execute switching between a synchronous mode and an asynchronous mode in a case where a displayed content of one of the display regions is set to a preset displayed content,
the synchronous mode being a mode in which the respective displayed contents of the display regions are synchronized,
the asynchronous mode being a mode in which the respective displayed contents of the display regions are not synchronized, and
execute switching to the synchronous mode while continuing to show a predetermined image in a synchronization source that is one of the display regions by maintaining a display setting of the synchronization source, and
increase number of facility types shown on the map displayed in the passenger display region and maintain number of facility types shown on the map displayed in the driver display region in response to executing switching to the asynchronous mode.

3. A vehicle display system comprising:
display regions including
a driver-assistant-seat display region being adjacent to a driver assistant seat of the vehicle, and
a back-seat display region being adjacent to a back seat of the vehicle;
a display controller configured to control respective displayed contents of the display regions;
synchronization switches, each of which is configured to be switched at a time where a synchronization instruction is provided by an occupant of a vehicle, the synchronization switches including
an assistant synchronization switch configured to be switched by an occupant sitting on the driver assistant seat, and
a back synchronization switch configured to be switched by an occupant sitting on the back seat; and
a switching controller configured to
execute switching between a synchronous mode and an asynchronous mode,
the synchronous mode being a mode in which the respective displayed contents of the display regions are synchronized,
the asynchronous mode being a mode in which the respective displayed contents of the display regions are not synchronized,
execute switching to the synchronous mode while continuing to show a predetermined image in a synchronization source that is one of the display regions by maintaining a display setting of the synchronization source,
execute the switching to the synchronous mode in response to switching one of the synchronization switches, and
set one of the display regions as the synchronization source being associated with one of the synchronization switches based on executing the switching to the synchronous mode by the one of the synchronization switches being switched.
